(19) United States
(12) Patent Application Publication
(10) Pub. No.: US 2026/0028460 A1
(43) Pub. Date: Jan. 29, 2026

(54) Erodible Film and Method of Making

(71) Applicant: Vipa Pharma, Inc., Cedar Park, TX (US)

(72) Inventors: Appala Raju Sagi, Cedar Park, TX (US); Shalini Sagi, Austin, TX (US); Arnav Sagi, Austin, TX (US); Arun Sagi, Austin, TX (US); Vishal Sagi, Austin, TX (US); Varun Bhupathiraju Raju, Dallas, TX (US); Amulya Bhupathiraju Raju, Philadelphia, PA (US); Vivek Sagi, Austin, TX (US); Padmaja Bhupathiraju, Campbell, CA (US); Rajeswari Sagi, Cedar Park, TX (US)

(21) Appl. No.: 19/246,819

(22) Filed: Jun. 24, 2025

Related U.S. Application Data
(60) Provisional application No. 63/675,039, filed on Jul. 24, 2024.

(51) Int. Cl. C08J 5/18

(52) U.S. Cl. CPC C08J 5/18; C08J 2301/02

(57) ABSTRACT

An erodible polymer film and a process of preparing the film includes steps of dissolving a polymer, which may be ethyl cellulose, in a primary solvent, which may be ethanol, and then adding a processing solvent, which may be water, to induce gel formation. The gel is cast and dried into a film that retains sufficient integrity for unidirectional delivery of active ingredients while being erodible in bodily fluids or biological environments over a period of time sufficient to allow effective delivery of the active ingredients, typically less than 10 hours. Erosion properties are adjustable by altering preparation parameters, such as polymer grade, solvent concentration, and film thickness.

### CROSS-REFERENCE TO RELATED APPLICATION

This application claims priority to U.S. Provisional Application No. 63/675,039, filed on Jul. 24, 2024, for Erodible Film and Method of Making, the entire content of which is hereby incorporated by reference.

### BACKGROUND

The inventive embodiments disclosed herein relate to an erodible film, erodible film component in a product assembly and an associated method of making. Preferably, the film/component is made from ethylcellulose (Ethocel), which has been modified via formation of a partial gel and dispersion in an alcohol solvent to impart desired disintegration characteristics.

Ethocel is commonly used in oral and topical formulations, pharmaceuticals, cosmetics, and food products. Ethocel is hydrophobic, possesses excellent water barrier properties and can be used as a backing film, for taste masking, and allows unidirectional release of an active component. In combination with other components, Ethocel can be used in control release of one or more active components by diffusion. Ethocel dissolved in organic solvent/solvent mix forms a water-insoluble film on its own and does not erode in body fluids during applications, thereby limiting its use due to safety and user experience.

It is known to modify Ethocel films to alter solubility or erosion properties, typically by incorporating one or more hydrophilic component(s) or plasticizer(s). A drawback to such modification is that it usually impacts other properties of the film, including its mucoadhesion and diffusion.

At present, there exists no form factor of standalone Ethocel film that permits disintegration or erosion of the polymer film in bodily fluids and/or during applications in a biological environment. Such a product would be useful in a myriad of end uses, including cosmetic products like Teeth whitening strips, dietary supplements, nutraceuticals, and drug products for buccal, sublingual, gingival and palatal delivery.

It would thus be useful to have an Ethocel film that erodes in bodily fluid and/or in a biological environment which is made from nonhazardous solvents and/or secondary components.

### SUMMARY

The disclosed embodiments provide an erodible film with sufficient quality and properties for use in vivo and associated method of making the erodible film.

The technology relies on addition of a processing solvent, such as water, to a homogenous solution of a polymer, such as Ethocel, in a primary solvent, such as ethanol, wherein the polymer is insoluble or practically insoluble in the processing solvent, but the processing solvent is miscible in the primary solvent. Addition of the processing solvent disrupts the solution and causes partial gelling of the polymer. Casting and drying the polymer gel mix ultimately yields polymer films that are intact, but susceptible to erosion when placed in an environment in contact with a bodily fluid such as saliva, optionally experiencing other anatomical factors such as tongue and muscle movements, unlike known films of the same material. In the preferred embodiment of Ethocel dissolved in ethanol with water addition to cause partial gelation of the solution, the process yields an erodible Ethocel film that have also been shown to be capable of unidirectionally delivering active materials.

The erodible films have been shown to stay sufficiently intact to act as a barrier and/or backing for delivery of an active material(s) without allowing diffusion in either direction (permitting unidirectional release of active material), while eroding over time due to the mechanical modification of the Ethocel provided by the synthetic process.

The erodible films have been shown to have adjustable properties (i.e., erosion time) via altering synthetic techniques and grade of Ethocel starting material.

In one embodiment, a method of forming an erodible polymer product includes a first step of dissolving a polymer starting material in a primary solvent (PS) to form a substantially homogeneous polymer-PS solution. Thereafter, a processing solvent is added to the polymer-PS solution. The processing solvent causes gelation of the polymer within the polymer-PS solution to form a gel mixture. The gel in the gel mixture may be dispersed via stirring, agitating or mixing, concurrently and/or after the processing solvent is added. The dispersed gel mixture is solvent cast to form a wet polymer product. The wet polymer product is dried to form the erodible polymer product.

In some embodiments, the gel mixture is mixed, agitated and/or stirred to form a homogeneous gel mixture prior to the step of solvent casting. Note that mixing, agitating and/or stirring may be performed concurrently and/or after addition of processing solvent to the polymer solution.

In some embodiments, the polymer is selected from cellulose acetate phthalate, hydroxypropyl-methyl cellulose phthalate, hydroxypropylmethyl cellulose acetate succinate, cellulose acetate trimellitate, carboxy methyl cellulose, ethyl cellulose, and polymethacrylate-based copolymers. In some preferred embodiments, the polymer may be ethyl cellulose.

In some embodiments, the primary solvent is selected from one or more alcohols and ketones. In some preferred embodiments, the primary solvent may be ethanol.

In some embodiments, the processing solvent is selected from one or more of water, glycerol and propylene glycol. In some preferred embodiments, the processing solvent may be water.

In one embodiment, an erodible film product is prepared by the disclosed process.

In some embodiments, the film allows substantially unidirectional release of an active ingredient provided on at least one surface of the film.

In some embodiments, the film is designed to erode into sub-film sections sufficient for swallowing by a human or animal in less than 10 hours when exposed to saliva of a human or animal subject.

In yet another embodiment, a method of forming an erodible film, comprises dissolving a polymer starting material selected from one or more of cellulose polymers and polymethacrylate-based copolymers in a primary solvent (PS) selected from one or more of the group consisting of alcohols, hydrocarbons and ethers to form a substantially homogeneous polymer-PS solution. A processing solvent selected from one or more of the group consisting of water, glycerol and propylene glycol is added to the polymer-PS solution to form a gel mixture. The mixture is solvent cast, forming a wet film that is dried to form the erodible film. The gel is dispersed within the gel mixture via one or more of stirring, agitating and mixing concurrently with the step of adding the processing solvent, after the step of adding processing solvent, or both. A duration of time required to erode the erodible film is adjustable via altering a concentration of the processing solvent added to the solution.

### BRIEF DESCRIPTION OF THE DRAWINGS

FIGS. 1 and 2 show photographs of initial partial gelling of Example 1;

FIG. 3 shows photographs of films formed from samples of Example 2.

FIG. 4 shows photographs of precipitation in films of higher molecular weight Ethocel at lower thresholds of water addition thresholds.

FIG. 5 shows photographs of films wherein precipitation was observed at a lower wet thickness.

FIG. 6 is a graph showing relative force at break for different sample films.

FIG. 7 shows photographs of Samples L and M films from Example 4.

FIG. 8 is a plot of yield of gel as a function of water addition for different concentrations and Ethocel grades.

FIG. 9 is a plot of yield of gel as a function of water addition with Ethocel grades combined.

FIG. 10 is a plot of Ethocel conversion into gel as a function of water addition for different concentrations and Ethocel grades.

FIG. 11 is a plot of Ethocel conversion as a function of water addition with Ethocel grades combined.

FIG. 12 shows photographs of film samples in Example 7 that differ based on water: Ethocel ratio and Ethocel content, showing phase separation in Sample Q.

FIG. 13 shows photographs of film samples in Example 8 that were prepared under different heating conditions.

FIG. 14 shows results of in vivo erosion testing of different films.

FIGS. 15-16 are photographs of film samples after in vivo testing.

FIG. 17 shows the paddle-over-disk apparatus and conditions used to test film samples for unidirectional release capabilities.

FIGS. 18 and 19 are plots that show cumulative active release data over time for the samples.

### DETAILED DESCRIPTION

Among the benefits and improvements disclosed herein, other objects and advantages of the disclosed embodiments will become apparent from the following wherein like numerals represent like parts throughout the figures. Detailed embodiments of an erodible film and associated method of making; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, “erode” and “disintegrate” and their other tenses are synonymous and generally mean to break up into smaller pieces with no significant risk of asphyxiation, which is expressly distinguished from “dissolve.” Film-film/coating/matrix. Typically, the erosion referenced herein concerns erosion in bodily fluids and/or during application in biological environment, and applies to embodiments of a film and/or film component of a more elaborate product assembly (i.e., film/coating/matrix).

As used herein, Ethocel “grade” is indicative of the respective solution viscosities, which is directly correlated with length of polymer chain. A higher grade and solution viscosity is produced by longer polymer chains from higher molecular weights. Thus the grade of Ethocel is directly correlated with its “molecular weight”.

As used herein, “solids content” or similar terminology refers to a concentration of polymer present in a solution or mixture.

As used herein, a “processing solvent” within the disclosed process is a solvent within which the respective polymer (Ethocel or other) is insoluble or practically insoluble, but which is miscible in the primary solvent (ethanol or other).

As used herein, “unidirectional release” within the disclosed embodiments relates to a product designed to release an active ingredient in a single direction, only toward the application site and not through the backing material. For example, in a unidirectional buccal film, release of the active ingredient(s) is towards the buccal mucosa, while release towards the oral cavity or saliva is prevented; an example of targeted delivery through buccal mucosa.

It has been found that an Ethocel film can be modified to erode into smaller parts in body fluids and/or during use. Most generally, a modified Ethocel film can be produced via stepwise dissolution of Ethocel in a primary solvent such as an alcohol, such as ethanol, followed by adding a processing solvent, such as water, to the Ethocel/alcohol solution. In the preferred embodiment, ethanol is the preferred alcohol solvent and water is the preferred processing solvent since they are nonhazardous and avoid health risks to an end user without compromising user experience. As those skilled in the art would readily understand, other solvents may reasonably be utilized without departing from the inventive spirit of the disclosure. For example, the primary solvent can be selected from one or more of alcohols, hydrocarbons and ethers, for example, methanol, ethanol, isopropanol, acetone, and methyl ethyl ketone, with ethanol being most preferred. Additionally, the processing solvent can be selected from one or more of water, glycerol and propylene glycol, with water being most preferred. Further, the polymer can be selected from one or more of cellulose polymers, such as cellulose acetate phthalate, hydroxypropyl-methyl cellulose phthalate, hydroxypropylmethyl cellulose acetate succinate, cellulose acetate trimellitate, carboxy methyl cellulose, and ethyl cellulose; polymethacrylate-based copolymers, such as poly(butyl methacrylate-co(2-dimethylamino) ethyl methacrylate-co-methyl methacrylate, poly(methacrylic acid-co-ethyl acrylate) and methacrylic acid-methyl methacrylate, with Ethocel being most preferred.

In the inventive process, water addition within a specific preferred range has been shown to cause partial gel formation of the Ethocel within the ethanol solution. This dispersion of the gel has been shown to alter the characteristics of a resulting Ethocel film, once dried, making the modified Ethocel film erodible during use by an individual. This is unlike unaltered Ethocel, and as will be discussed in detail below, even imparts different properties on the resulting film product from Ethocel modified in an ethanol/water mixed solvent (in contrast to dissolved in ethanol, followed by water addition).

The range of water/processing solvent concentration includes up to 70% by weight, and is necessarily dependent on the type and grade of polymer starting material, identity of primary solvent, film thickness, and desired product properties (for example, preferred time to erode). In preferred embodiments, water concentration is within an approximate range of 0.5% to 50%, and more preferably within an approximate range of 2% to 30%.

The preferred range of ethanol/primary solvent concentration includes up to 99% by weight. It is also dependent on other factors, including type and grade of polymer starting material, identity of primary solvent, film thickness, and desired product properties (for example, preferred time to erode). All such properties of the film product are adjustable via adjusting one or more of the preceding factors. In preferred embodiments, primary solvent concentration is within an approximate range of 25% to 90%, and more preferably within an approximate range of 40% to 85%, and even more preferably within an approximate range of 50% to 85%. Typically, the concentration of primary solvent is greater than the concentration of processing solvent in the mixture, however, this is not a limiting characteristic of the inventive embodiments.

In illustrative preferred embodiments that utilize Ethocel in ethanol primary solvent and water processing solvent, it has been shown that the erosion rate of the resulting modified Ethocel film can be controlled or directed by varying the amount of water introduced into the Ethocel/ethanol solution during the manufacturing process. Erosion rate can also be controlled by using different grades of Ethocel as starting material. As such, provided herein is a novel and inventive product and process that is fully variable to yield polymer film products that erode at a multitude of different rates useful in a multitude of different consumer products.

### EXAMPLES

In the below examples, an Ethocel/ethanol solution was first prepared by dissolving Ethocel in ethanol. Thereafter, different predetermined amounts of water were added slowly to cause partial gelation of the Ethocel within the solution, and the gel was dispersed within the solution by gentle mixing. A thin Ethocel film was prepared from the mixture by solvent casting and drying. While all examples include Ethocel in ethanol with water addition, the inventive concepts are not so limited. Those skilled in the art will understand that the inventive concepts and method illustrated in the Examples extend to other similar polymeric materials and other similar primary and processing solvents.

### Example 1

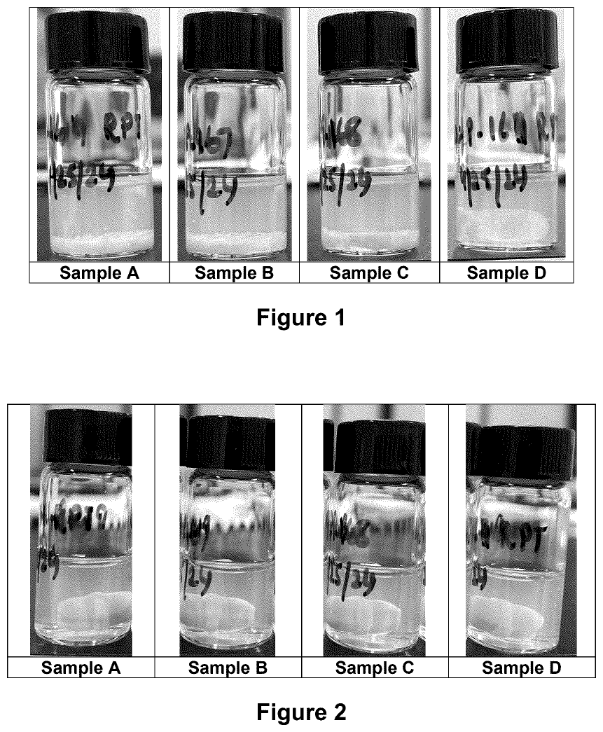

Example 1 shows differing results for gelling within the Ethocel/ethanol solution, followed by dispersion, with varying amounts of water. FIGS. 1 and 2 show photographs of the initial partial gelling (FIG. 1) for four different samples and the mix after gel dispersion by stirring (FIG. 2) (compositions by weight percent):
Sample A: 70% ethanol, 20% Ethocel 4, 10% water.
Sample B: 68% ethanol, 20% Ethocel 4, 12% water.
Sample C: 65% ethanol, 20% Ethocel 4, 15% water.
Sample D: 60% ethanol, 20% Ethocel 4, 20% water.

As can be seen, partial gelling within a given mix increases as water concentration increases. Adding water in this controlled manner acts to transform the homogeneous Ethocel-ethanol solution into a heterogenous mix, which is different from known processes of forming emulsions or solutions of Ethocel in an Ethocel-alcohol and Ethocel-alcohol/water mixed solvent. As will be shown below, this process also yields markedly different results from modifying and/or dissolving Ethocel in an alcohol/water mixed solvent.

### Example 2

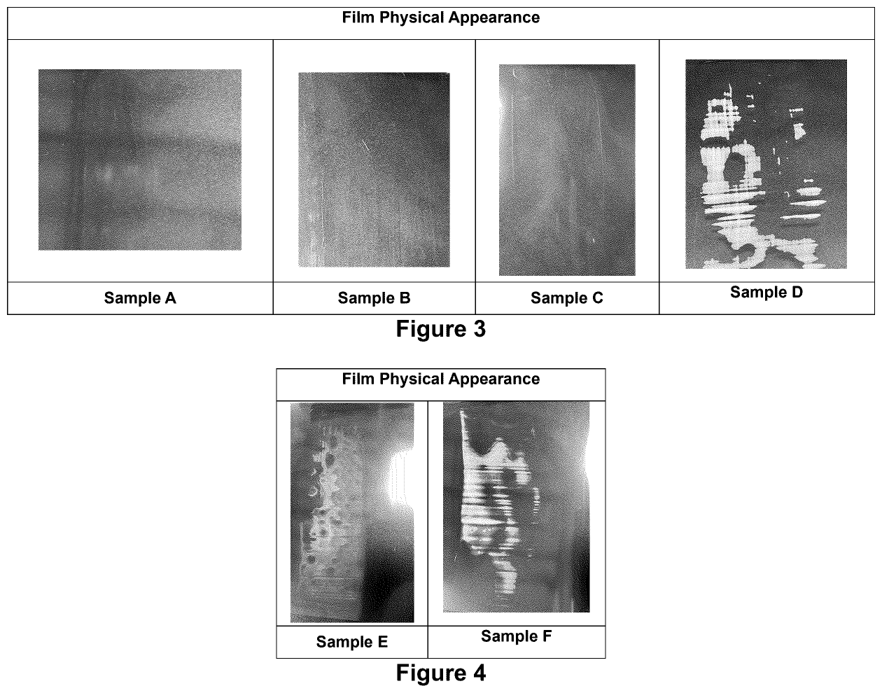

In Example 2, films were formed from each of Samples A, B, C and D by wet casting to a thickness of approximately 3 mil and then drying at 70° C. for 5 minutes. The physical appearances of the resulting films were observed. FIG. 3 shows photographs of films formed from these Samples.

Samples A, B and C films were each observed to be uniform and clear, however, the Sample D showed precipitation/phase separation of Ethocel (white portion in FIG. 3).

For a given thickness of film, different grades (i.e., molecular weights) of Ethocel will necessarily have different thresholds for water addition before causing precipitation from the mix. The threshold decreases as Ethocel molecular weight increases. FIG. 4 shows photographs of precipitation in films of higher molecular weight Ethocel at lower thresholds of water addition thresholds. Samples E and F were wet cast at a thickness of 3 mil:
Sample E: 67% ethanol, 16.5% Ethocel 10, 16.5% water.
Sample F: 87% ethanol, 6.5% Ethocel 100, 6.5% water.

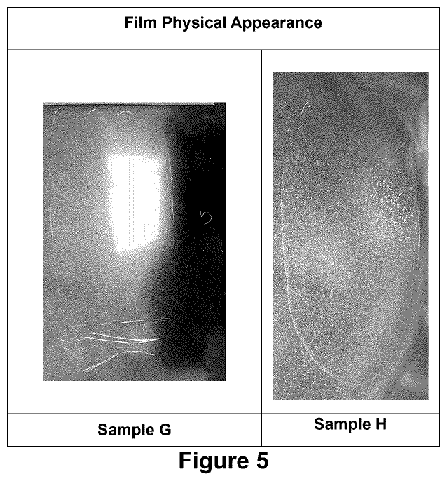

Additionally, for a given grade of Ethocel, as wet cast thickness increases, so too does the threshold for water addition before causing precipitation. Conversely, increase in wet cast thickness decreases Ethocel precipitation in the finished film. FIG. 5 shows photos of the films wherein precipitation that was observed at a lower wet thickness (Samples E and F) had disappeared when cast at a higher wet thickness.
Sample G: Sample E wet cast at thickness of 6 mil.
Sample H: Sample F wet cast at thickness of 10 mil.

### Example 3

Example 3 shows the efficacy of the disclosed embodiments for forming a film with different properties as compared to a film formed without water addition and a film formed from dissolving Ethocel in a premixed ethanol/water solution.

Films were formed from three additional samples in accordance with the above described process:
Sample 1: 80% ethanol, 20% Ethocel 10.
Sample J: 20% Ethocel 10 dissolved in solvent mix with 67% ethanol and 13% water.
Sample K: 67% ethanol, 20% Ethocel 10, 13% water added to Ethocel-ethanol solution.

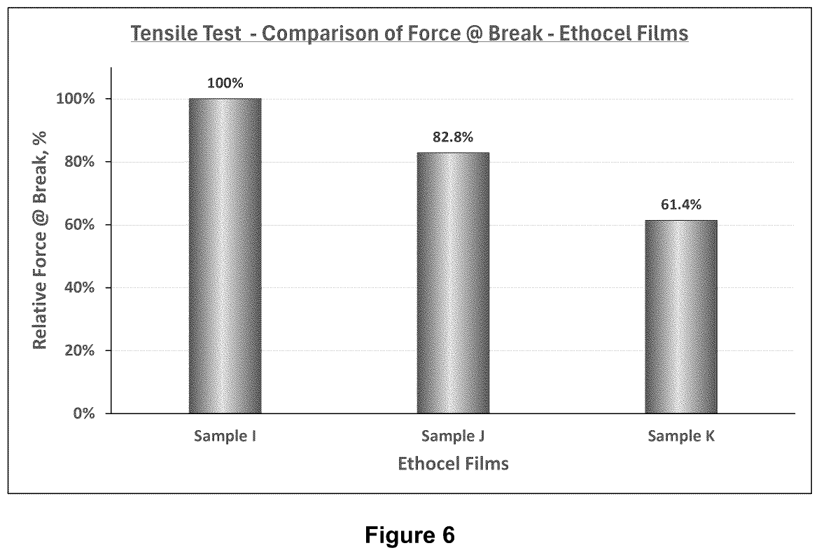

Film samples of 100 μm wet cast thickness were prepared from each of Samples I-K and subjected to a tensile test in triplicate to determine relative mechanical strength (i.e., force at break) with the Sample I film (control) being assigned 100%. FIG. 6 shows the relative force at break for each of the sample films, showing that the Sample K film formed by the inventive process exhibited a substantial reduction in force at break (61.4%) relative to the Sample J film formed from a known process utilizing an ethanol/water solvent mixture (82.8%).

### Example 4

Erosion times for films applied in vivo were observed for two different sample films in Example 4 to compare erosion time of different grades of Ethocel:
Sample L: 60% ethanol, 20% water, 20% Ethocel 4.
Sample M: 67% ethanol, 16.5% water, 16.5% Ethocel 10.

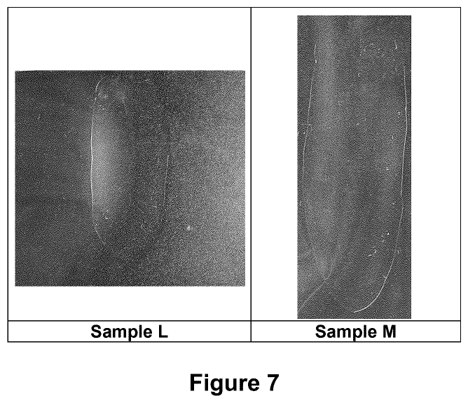

A higher concentration of ethanol was required in Sample M to dissolve Ethocel 10 with higher molecular weight. For each of Examples L and M, a film of a wet casting thickness of 10 mil was prepared by the above described process of dissolving Ethocel in ethanol, followed by slow addition of water to yield a partial gel, followed by initiating dispersion, and wet casting and drying at 70° C. for 5 minutes. The Sample L film had a finished thickness of 27 μm and the Sample M film had a finished thickness of 20 μm—thinner in comparison to the Sample L film due to lower solids content. Each film in a sample of 1 cm2 size was tested sublingually for erosion during wear in a volunteer. The end point for erosion was considered the time point when the film breaks up into smaller pieces and swallowed along with saliva. The Sample L film was shown to erode in 40 minutes and the Sample M film was shown to erode under the same conditions in 110 minutes even though the film was thinner. FIG. 7 shows photographs of the Samples L and M films.

Example 4 shows that Ethocel grades with higher molecular weight Ethocel erode more slowly. It is believed that for a given grade of Ethocel, thinner films will disintegrate faster.

### Example 5

In Example 5, three different grades and concentrations of Ethocel were tested using the disclosed processes, stepwise dissolving in ethanol followed by slow addition of water, with different water:Ethocel ratios to determine the respective yield of gel as a function of water concentration:

| | |
|---|---|
| EC concentration/grade | Water:EC ratio |

| | | | | |
|---|---|---|---|---|
| 20% EC 4 | 2 | 4 | 6 | 8 |
| 18% EC 7 | 2.5 | 5 | 7.5 | 10 |
| 16.5% EC 10 | 3 | 6 | 9 | 12 |

Ethocel was dissolved in ethanol, followed by addition of the respective amounts of water. The dispersion was allowed to stand for 2 hours, and then the supernatant liquid was removed and the remaining gel was weighed.

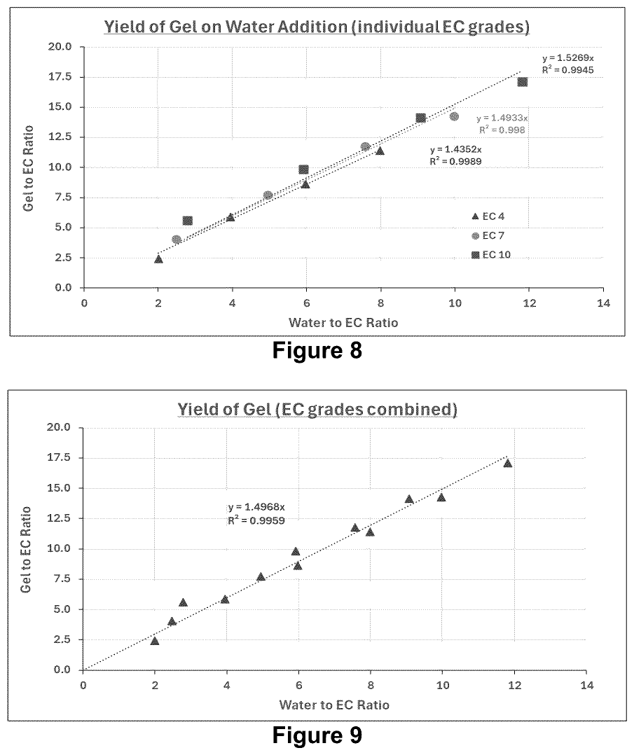

FIG. 8 is a plot of yield of gel as a function of water addition for each concentration and Ethocel grade. FIG. 9 is a plot of yield of gel as a function of water addition with Ethocel grades combined. As can be seen, the results show a distinct linear relationship between water:EC ratio and gel:EC ratio: gel yield increases linearly (1.5×) with water addition to the Ethocel/ethanol solution.

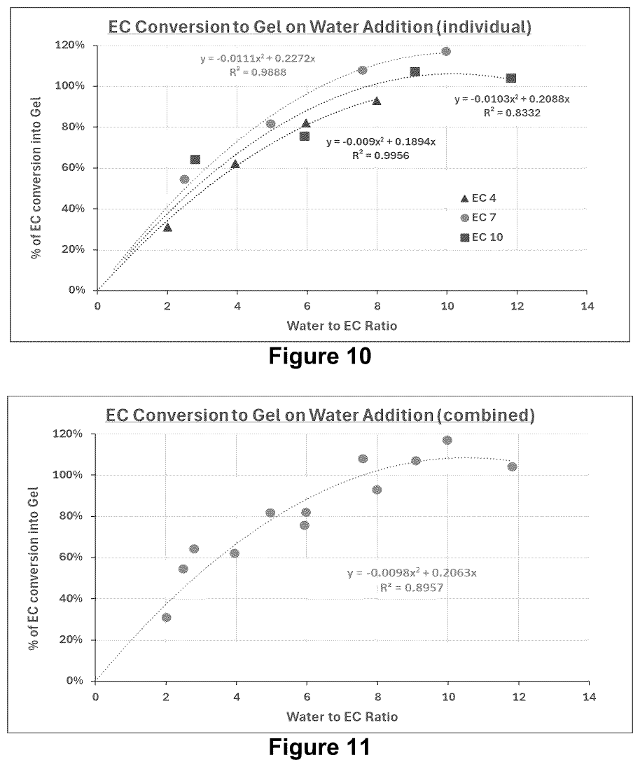

Thereafter the samples of gel were dried in an oven at 105° C. for 2 hours to determine the quantity of Ethocel conversion as a function of water concentration. FIG. 10 is a plot of Ethocel conversion into gel as a function of water addition for each concentration and Ethocel grade, and FIG. 11 is a plot of Ethocel conversion as a function of water addition with Ethocel grades combined. The results show a quadratic relationship between water:EC ratio and gel conversion rate. Gelling peaks at an approximate water:EC ratio of 10, which corresponds to an approximate gel:EC ratio of 15.

### Example 6

Impact of Ethocel grade (molecular weight) and solubility on phase separation was tested and observed in Example 6, and ultimately show that solubility of Ethocel in ethanol solvent decreases with an increase in molecular weight (grade). The stock solutions shown in Table 1 were prepared by keeping Ethocel concentration slightly lower than solubility for convenience of handling, and the data shows this phenomenon. Further, as mixes are prepared from the stock Ethocel/ethanol solutions, there is a corresponding decrease in the content of Ethocel in mixes with water for preparation of erodible films according to the disclosure. The data ultimately shows that lower solids content in the ethanol solution and water/ethanol mixture should be used with higher grades of Ethocel mixes for preparation of the disclosed erodible films.

TABLE 1
Ethocel

| | EC content in | EC content in |
|---|---|---|
| Grade | ethanol solution | water/ethanol mix |
| 4 | 30% | 20% |
| 7 | 27% | 18.5% |
| 10 | 22.5% | 16.5% |
| 20 | 20% | 13.5% |
| 100 | 10% | 6.5% |

### Example 7

Example 7 shows the impact of water: Ethocel ratio on phase separation using Ethocel 100. Four samples were prepared using the disclosed method, each with increasing water:Ethocel content:

| | Sample N | Sample O | Sample P | Sample Q |
|---|---|---|---|---|
| Water:EC | 2 | 3 | 4 | 5 |
| EC content | 8.33% | 7.69% | 7.14% | 6.67% |

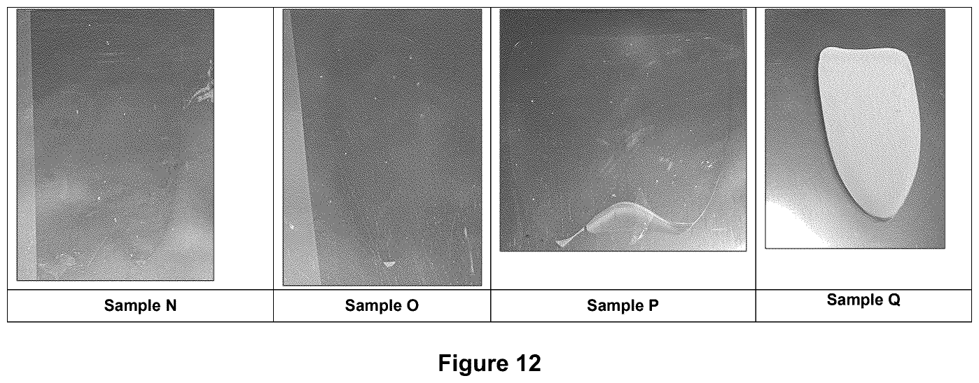

Each of the film Samples N-Q was prepared with 15 mil wet coat thickness. Only Sample Q experienced phase separation in the finished film, as shown in FIG. 12, ultimately showing that there is a threshold of water:Ethocel ratio to avoid phase separation for a given grade of Ethocel.

### Example 8

The impact of drying temperature on phase separation for three different grades of Ethocel was observed in Example 8. Three homogenous mixes with gel dispersion were prepared according to the disclosed methods, and each was used to prepare a wet film, and then dried at different temperatures.
Sample R: Ethocel 4, 20% solids, 5 mil wet coat.
Sample S: Ethocel 10, 16.5% solids, 5 mil wet coat.
Sample T: Ethocel 100, 6.5% solids, 15 mil wet coat.

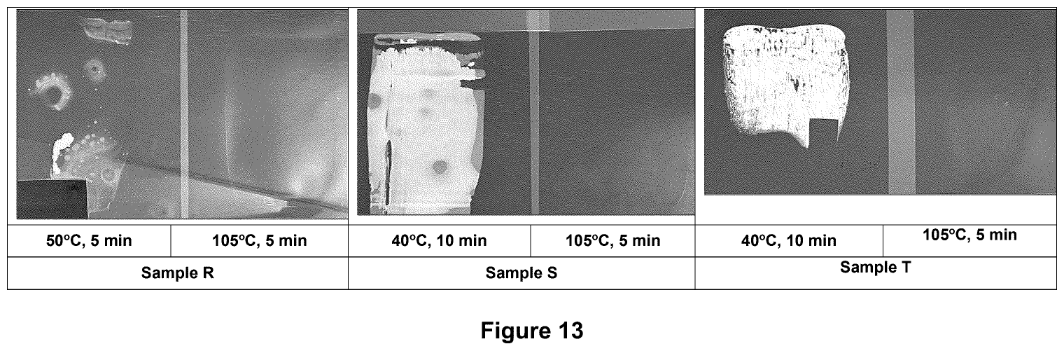

With reference to FIG. 13, the results of Example 8 show that drying at lower temperatures is more likely to yield films with phase separation. Each of Samples R-T exhibited phase separation when drying at temperatures 40-50° C., whereas none of them exhibited phase separation when drying at 105° C. The ethanol-water evaporation rates are not the same at different temperatures. The relative evaporation rate of ethanol and water changes with temperature due to differences in their vapor pressures. The vapor pressure of ethanol increases faster than that of water at lower temperatures, but the vapor pressure of water catches up to that of ethanol more rapidly at higher temperatures. Due to this phenomenon, the lower boiling ethanol in the mix will evaporate early when drying at lower temperatures, leaving Ethocel in a higher concentration of water, causing the Ethocel to separate. On the other hand, when drying at higher temperature, both ethanol and water evaporate simultaneously, producing a transparent film without separation. This is preferred.

The inventive embodiments described herein have shown to be effective for forming a partial gel dispersion from an Ethocel/ethanol solution by controlled addition of water, transforming the homogeneous solution into a heterogenous mix. Dispersing the gel in this controlled manner has shown to disperse the heterogeneity across the mix. Thereafter, when such a mix is processed into a thin film by casting and drying, the properties of the finished film are different from film made from a homogeneous mix of Ethocel in an ethanol/water solution. The properties of the film product can be altered and tailored to meet specific needs by controlling the amount of water addition, as well as varying the grade of Ethocel used.

### Example 9

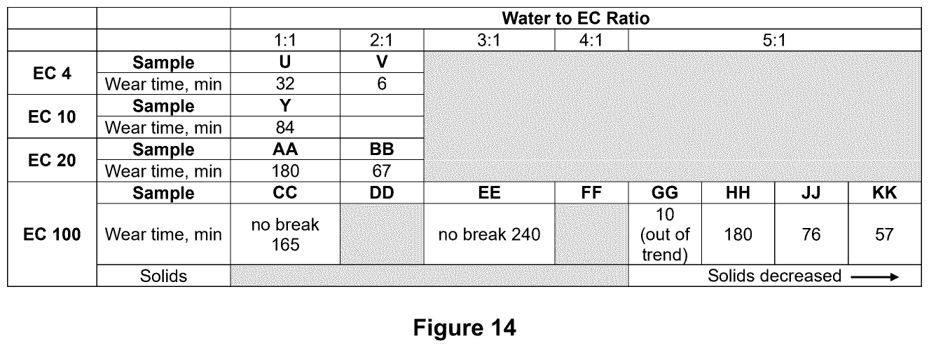

In Example 9, numerous samples of erodible films were prepared according to the disclosed method. Each film sample differed on the basis of Ethocel grade and water:Ethocel ratio used for preparation. Each of the resulting films was tested in vivo by applying it to a human subject's tongue, moving it to the palate and recording the duration that elapsed before the film broke apart into multiple smaller pieces. The same human subject was used for each sample. The results of Example 9 are shown in FIG. 14.

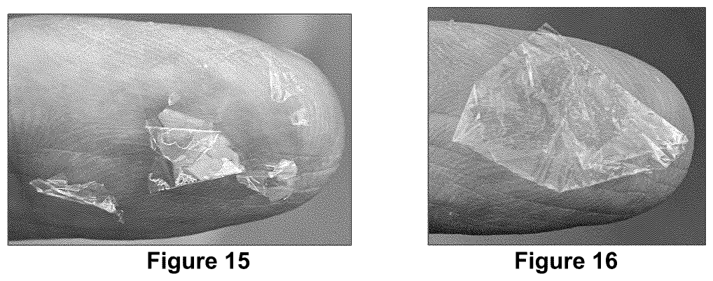

The results of Example 9 provided in FIG. 14 indicate that erosion/wear time increases as Ethocel grade increases and erosion/wear time decreases as water:Ethocel ratio increases (Samples CC-HH), and at a given water to EC ratio, erosion/wear time decreases as solids decreased (HH-KK). FIG. 15 is a photograph of Sample AA after 180 minutes of wear time, showing erosion into several smaller pieces. FIG. 16 is a photograph of Sample EE after 240 minutes of wear time, showing the film sample still intact.

The disclosed inventive embodiments provide the ability for making erodible films while adjusting key properties of them.

### Example 10

A sample of the disclosed erodible Ethocel film was tested to establish unidirectional release ability for an active ingredient in Example 10. An active matrix layer was prepared with melatonin, HPMC (hydroxypropyl methyl cellulose), PEO (polyethylene oxide), EC (ethyl cellulose), PVP (polyvinylpyrrolidone), plasticizer (glycerin), sweetener (saccharin sodium), pH adjuster (citric acid), and flavoring agent (menthol) in ethanol and water solvent. The ingredients of the active layer were mixed until a homogeneous mixture was formed. The mixture was thereafter processed into a 0.5 mm thick wet film and then dried in an oven to yield the exemplary active matrix. An erodible backing film layer was prepared according to the disclosed embodiments, using Ethocel 20 in ethanol followed by water addition. The final composition of the mixture used to prepare the film used in Example 10 was Ethocel 20:ethanol:water::13.5:73:13.5 to form gel. The gel was thereafter wet cast and dried at 105° C. for 5 minutes to form the erodible film backing. The erodible backing and active matrix layers were laminated as customary in the industry to form a film composite, and testing samples of ⅝″ diameter were punched from the film composite.

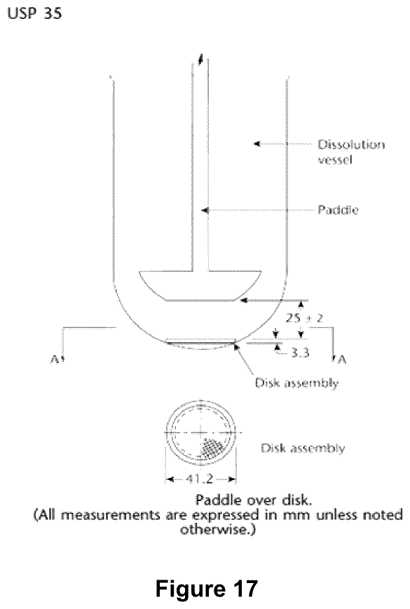

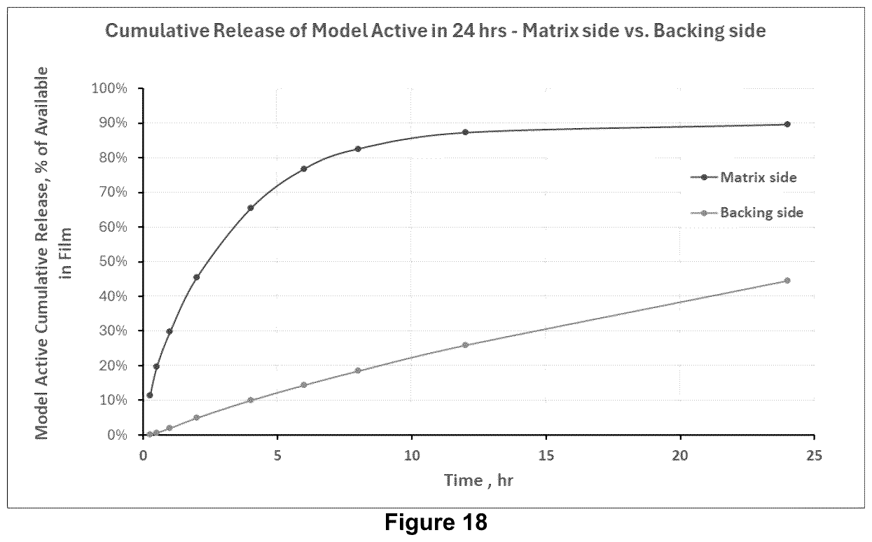

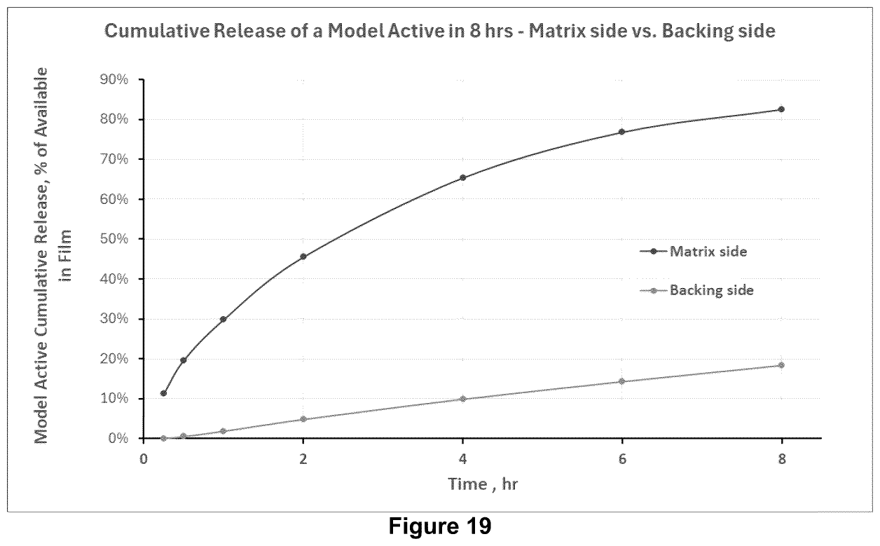

The film samples were tested for active release using United States Pharmacopeia (USP), Chapter <724>Drug Release, Apparatus 5 Paddle-Over-Disk apparatus and procedure, in watch glass conditions using the apparatus shown in FIG. 17, which is widely accepted in the relevant field. Two test runs were performed using water as the dissolution medium-a first test arranged with erodible film/active matrix samples matrix facing up toward dissolution medium and erodible backing layer facing down towards the watch glass, and a second test arranged with the erodible film backing layer facing up toward the dissolution medium and the active matrix toward the watch glass. Test samples were drawn at regular intervals over a 24 hour duration and analyzed according to accepted industry standards using HPLC. FIGS. 18 and 19 show cumulative active release data over time for the samples. The wear period for the sustained release buccal or sublingual products is typically within an approximate range of 4-8 hours. FIG. 19 shows how the release from the backing film side was significantly reduced during this period. The small amounts of release still seen are considered to be from the periphery; not an area covered by the backing film.

Example 10 clearly establishes that the disclosed erodible backing layer acts as an effective barrier for facilitating unidirectional active release from the active matrix layer of the film.

Clearly, as those skilled in the art will readily understand, the specific samples used in the disclosed examples are not limiting to the inventive nature of the embodiments. For example, the erodible film backing layers can be used for delivery of one or more active ingredients selected from the non-limiting group of ashwagandha, baclofen, buprenorphine, caffeine, cannabidiol, clonidine, curcumin, desmopressin, diphenhydramine or cetirizine, donepezil or rivastigmine, gabapentin, iron, ketamine, low-dose trazodone or mirtazapine, L-theanine, magnesium, melatonin, midazolam, nicotine, nitroglycerin, ondansetron, oxazepam, propranolol, risperidone, rizatriptan, tadalafil, tizanidine, vitamin B12, xylitol, and zinc.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A method of forming an erodible polymer product, comprising:
(a) dissolving a polymer starting material in a primary solvent (PS) to form a substantially homogeneous polymer-PS solution;
(b) adding a processing solvent to the polymer-PS solution, wherein the processing solvent mixes with the primary solvent and causes gelation in the polymer-PS solution to form a gel mixture;
(c) solvent casting the gel mixture to form a wet polymer product; and
(d) drying the wet polymer product to form the erodible polymer product.

2. The method of claim 1, wherein the polymer product is a film.

3. The method of claim 1, wherein the primary solvent is selected from one or more alcohols and ketones.

4. The method of claim 1, wherein the processing solvent is selected from one or more of water, glycerol and propylene glycol.

5. The method of claim 1, wherein the polymer is selected from one or more of cellulose acetate phthalate, hydroxypropyl-methyl cellulose phthalate, hydroxypropylmethyl cellulose acetate succinate, cellulose acetate trimellitate, carboxy methyl cellulose, ethyl cellulose, and polymethacrylate-based copolymers.

6. The method of claim 1, wherein the primary solvent is an alcohol.

7. The method of claim 6, wherein the primary solvent is ethanol.

8. The method of claim 1, further comprising a step of initiating dispersion of the gel in the gel mixture by mixing or agitating concurrently with step (b), after step (b), or both.

9. The method of claim 8, wherein the processing solvent is water.

10. The method of claim 1, wherein the processing solvent is water.

11. The method of claim 9, wherein the polymer is ethylcellulose (Ethocel).

12. The method of claim 1, wherein the polymer is ethylcellulose (Ethocel).

13. The method of claim 1, wherein the concentration of polymer in the polymer-PS solution is within an approximate range of 0.5 to 25 percent; and
the concentration of polymer in the gel mixture is within an approximate range of 0.25 to 24.5 percent.

14. The method of claim 1, wherein the step of drying is performed at a temperature above 100° C.

15. The method of claim 1, further comprising steps of:
(e) providing an active layer of one or more active ingredients; and
(f) laminating the active layer to at least one surface of the erodible product to yield an active erodible product, wherein
the one or more active ingredients are releasable from the active layer in vivo.

16. An erodible film product formed by the process of claim 1.

17. The erodible film product of claim 16, wherein
the film allows unidirectional release of an active ingredient for targeted delivery from one side only; and
the film erodes into sub-film sections sufficient for swallowing by a human or animal in less than 10 hours when exposed to saliva of a human or animal subject.

18. The erodible film product of claim 16, wherein the polymer is ethyl cellulose.

19. The erodible film product of claim 16, comprising an active layer of one or more active ingredients on one or more surfaces of the film, wherein the one or more active ingredients is selected from the group consisting of ashwagandha, baclofen, buprenorphine, cannabidiol, caffeine, clonidine, curcumin, desmopressin, diphenhydramine or cetirizine, donepezil or rivastigmine, gabapentin, iron, ketamine, low-dose trazodone or mirtazapine, L-theanine, magnesium, melatonin, midazolam, nicotine, nitroglycerin, ondansetron, oxazepam, propranolol, risperidone, rizatriptan, tadalafil, tizanidine, vitamin B12, and zinc.

20. A method of forming an erodible film, comprising:
dissolving a polymer starting material selected from one or more of cellulose polymers and polymethacrylate-based copolymers in a primary solvent (PS) selected from one or more of the group consisting of alcohols, hydrocarbons and ethers to form a substantially homogeneous polymer-PS solution;
adding a processing solvent selected from one or more of the group consisting of water, glycerol and propylene glycol to the polymer-PS solution to form a gel mixture;
solvent casting the gel mixture to form a wet film; and
drying the wet film to form the erodible film, wherein
the gel is dispersed within the gel mixture initiated via one or more of stirring, agitating and mixing concurrently with the step of adding the processing solvent, after the step of adding processing solvent, or both; and
a duration of time required to erode the erodible film is adjustable via altering a concentration of the processing solvent added to the solution.
